(19) United States
(12) Patent Application Publication
(10) Pub. No.: US 2012/0137589 A1
(43) Pub. Date: Jun. 7, 2012

(54) DOOR WITH RETRACTABLE SCREEN

(76) Inventor: Marshall D. Christie, Durango, CO (US)

(21) Appl. No.: 12/960,151

(22) Filed: Dec. 3, 2010

(51) Int. Cl. E06B 3/50; B23P 11/00; E06B 7/16

(52) U.S. Cl. 49/168; 29/428

(57) ABSTRACT

A door, including: an opening passing through the door; a first panel hingedly connected to the door between the opening and a bottom edge of the door such that in a closed position the panel covers the opening and in an open position all of the panel is aligned with the door between the opening and the bottom edge; and a screen assembly secured to the door and including a displaceable screen. For the open position, the screen is extendable to cover the opening. For the closed position, the screen is retractable about a coil.

### TECHNICAL FIELD

The invention relates generally to doors, specifically, to a door with a built-in retractable screen.

### BACKGROUND

It is known to provide a separate screen door to provide ventilation at an exterior doorway. It also is know to provide fixed screens, slideable screens, or removable screens for a door.

### SUMMARY

According to aspects illustrated herein, there is provided a door, including: an opening passing through the door; a first panel hingedly connected to the door between the opening and a bottom edge of the door such that in a closed position the panel covers the opening and in an open position all of the panel is aligned with the door between the opening and the bottom edge; and a screen assembly secured to the door and including a displaceable screen. For the open position, the screen is extendable to cover the opening. For the closed position, the screen is retractable about a coil.

According to aspects illustrated herein, there is provided a method of fabricating and operating a door, comprising: forming an opening in door; hingedly connecting a first panel to the door between the opening and a bottom edge of the door; and securing a screen assembly to the door. The first panel is displaceable to cover the opening in a closed position. The first panel is displaceable such that the first panel is aligned with the door between the opening and the bottom edge in an open position. The screen assembly includes a screen extendable to cover the opening in the open position and retractable about a coil in the closed position.

According to aspects illustrated herein, there is provided a door, including: an opening passing through the door; a first panel; a second panel between the opening and a bottom edge of the door; a lock rail between the first and second panels; at least one hinge connected to the first panel and to the lock rail; and a screen assembly secured to the door and including a displaceable screen and a coil about which the screen is retractable. The screen assembly is located between the opening and a top edge of the door. In a closed position, the first panel fits within the opening to fill the opening and the screen is retracted about the coil. In an open position, at least a portion of the first panel faces the second panel and the screen is extended beyond the coil to overlap the opening.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front view of a door with a retractable screen in a closed mode;

FIG. 2 is a back view of the door shown in FIG. 1;

FIG. 3 is a front view of the door shown in FIG. 1 in an open mode;

FIG. 4 is a back view of the door shown in FIG. 3;

FIG. 5 is a cross-sectional view of the door shown in FIG. 1, generally along line 5-5 in FIG. 1;

FIG. 6 is a cross-sectional view of the door shown in FIG. 3, generally along line 6-6 in FIG. 3;

FIG. 7 is a partial cross-sectional view of the door shown in FIG. 2, generally along line 7-7 in FIG. 2; and,

FIG. 8 is a back view of a three panel door.

### DETAILED DESCRIPTION

At the outset, it should be appreciated that like drawing numbers on different drawing views identify identical, or functionally similar, structural elements of the disclosure. It is to be understood that the disclosure is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the disclosure. Unless defined otherwise, all technical and scientific terms used herein have the same meaning as commonly understood to one of ordinary skill in the art to which this disclosure belongs.

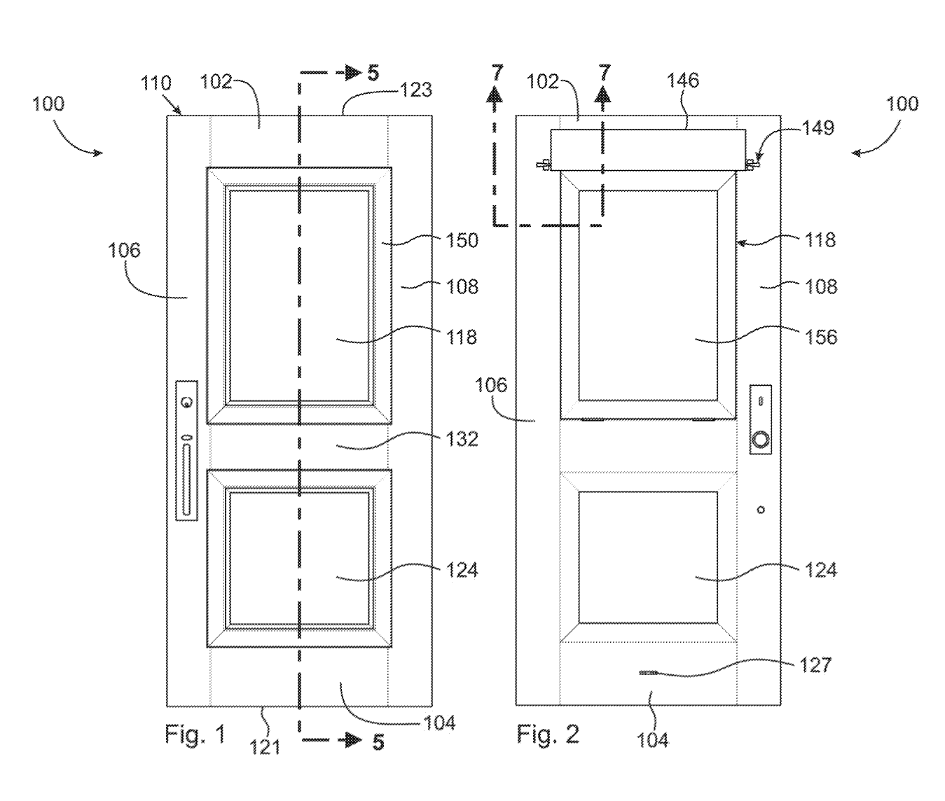

FIG. 1 is a front, or exterior, view of door 100 with a retractable screen in a closed mode.

FIG. 2 is a back, or interior, view of door 100 shown in FIG. 1.

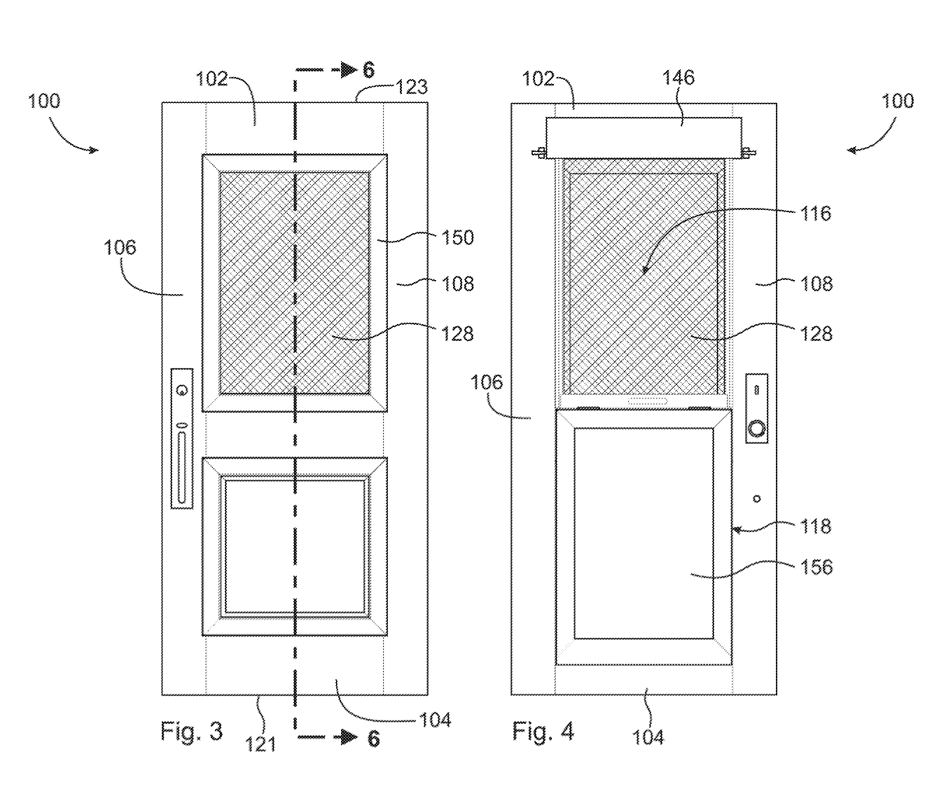

FIG. 3 is a front view of door 100 shown in FIG. 1 in an open mode.

FIG. 4 is a back view of door 100 shown in FIG. 3. The following should be viewed in light of FIGS. 1 through 4. Door 100 includes a plurality of structural elements forming an outer circumference for the door. In one embodiment, top rail 102, bottom rail 104, and side stiles 106 and 108 form outer circumference 110 of the door.

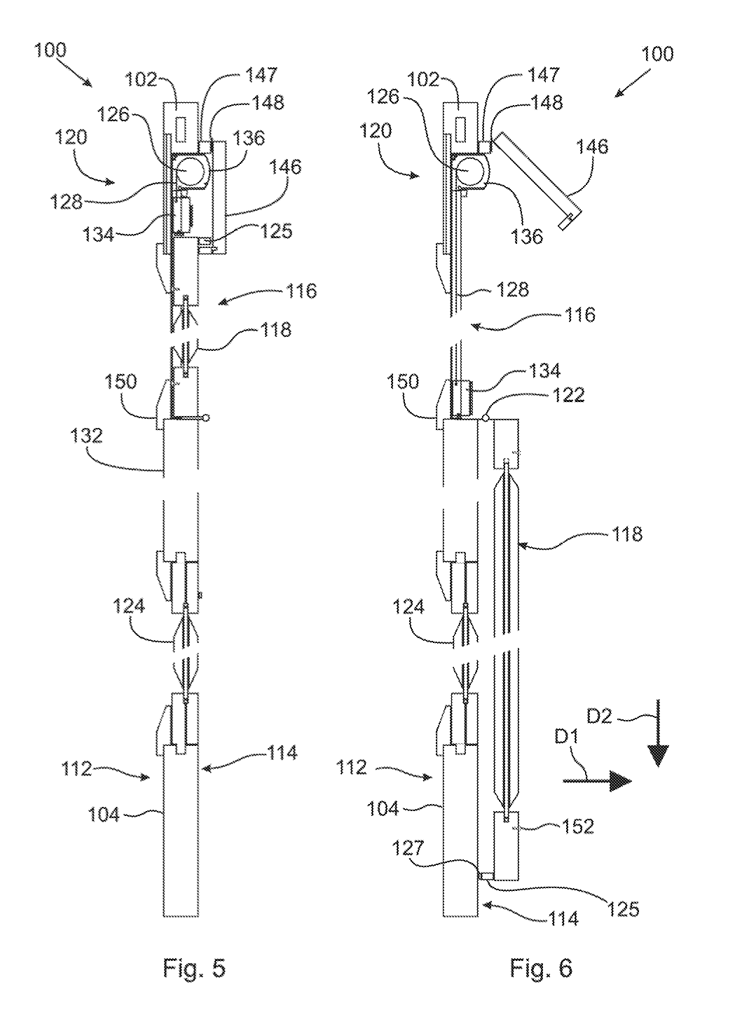

FIG. 5 is a cross-sectional view of door 100 shown in FIG. 1, generally along line 5-5 in FIG. 1.

FIG. 6 is a cross-sectional view door 100 shown in FIG. 3, generally along line 6-6 in FIG. 3. The following should be viewed in light of FIGS. 1-6. The rails and stiles also form parallel front side 112 and back side 114 of the door. By rail, we mean a horizontal structural member of the door. The top and bottom rails form the horizontal outer framework and edges of the door. By stile, we mean a vertical structural member of the door. The side stiles form the vertical outer framework and edges of the door. For example, hardware (not shown) for mounting the door to a door frame is attached to one of the side stiles. By top rail, we mean the rail furthest from the ground or floor when the door is installed. By bottom rail, we mean the rail closest to the ground or floor when the door is installed. In general, the top rail and side stiles are aligned with a door jamb to which the door is to be connected. It should be understood that other configurations and structural elements can be used to form outer circumference 110 and sides 112 and 114.

Door 100 includes opening 116 passing through the door, panel 118, and screen assembly 120. Panel 118 is hingedly connected to the door between the opening and bottom edge 121 of the door, for example, between the opening and the bottom rail. In an example embodiment, at least one hinge 122 is used to connect panel 118 to the door. In a closed position, for example, as shown in FIGS. 1, 2, and 5, panel 118 covers the opening. For example, panel 118 fits within the opening and substantially fills the area of the opening. In an example embodiment, assembly 120 is between the opening and top edge 123 of the door.

In an open position, for example, as shown in FIGS. 3, 4, and 6, all of panel 118 is aligned, in direction D1, orthogonal to back side 114, with the door between the opening and the bottom edge. Thus, in an example embodiment, panel 118 pivots about an axis for the hinges generally in direction D2, toward the bottom rail. That is, to transition between the closed and open positions, panel 118 pivots about the axis. In one embodiment, panel 118 includes catch 125 and tension fastener 127 which engages the catch in the open position. Catch 125 and fastener 127 also hold the panel off of the door and substantially parallel with surface 114.

In an example embodiment, door 100 includes panel 124 between the opening and the bottom rail. In the open position for panel 118, at least respective portions of panels 118 and 124 are in registration with, that is, aligned with, respect to direction D1. Stated otherwise, in the open position for panel 118, at least a portion of panel 118 faces panel 124.

In an example embodiment, the door includes lock rail 132 between panel 124 and the opening, and hinges 122 are connected to lock rail 132.

In an example embodiment, the screen assembly includes coil 126 secured to the door and screen 128 retractable about the coil. That is, the screen can be rolled, or coiled, about the coil. In an example embodiment, the coil is secured to the door between the opening and the top edge of the door. In the open position for panel 118, the screen can be extended beyond the housing to cover the opening, for example, as shown in FIGS. 3, 4, and 6, the screen can be unrolled from the coil. In the closed position for panel 118, for example, as shown in FIGS. 1, 2, and 5, the screen is retracted, that is, coiled or rolled about the coil to remove the screen from the opening. Thus, when panel 118 is in the open position, the screen can be extended to cover the opening, and when panel 118 is in the closed position, the screen can be retracted so as to be concealed from sight, as further discussed below.

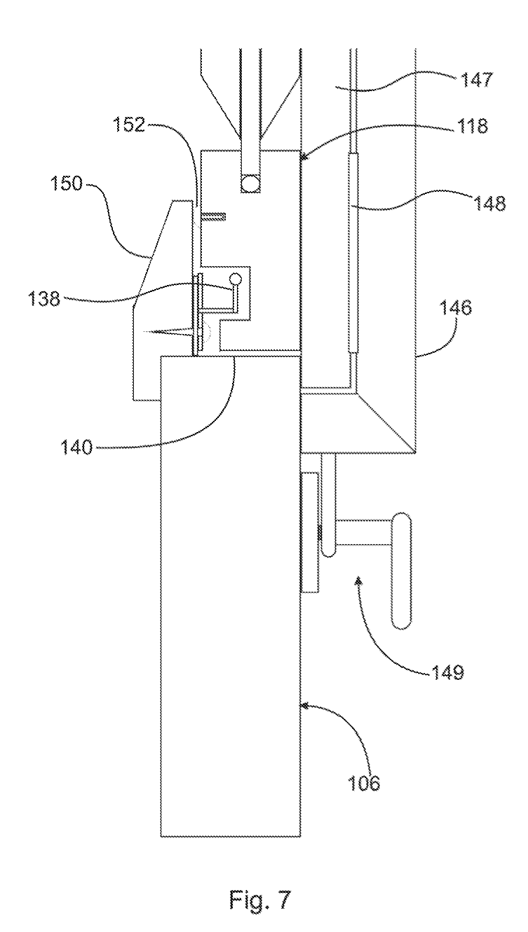

FIG. 7 is a partial cross-sectional view of the door shown in FIG. 2, generally along line 7-7 in FIG. 2. The following should be viewed in light of FIGS. 1 through 7. The screen assembly can be any screen assembly known in the art. In an example embodiment, the screen assembly includes screen pull bar 134 to which the screen is attached, housing 136 in which the coil is located, and tracks 138 located proximate edges 140 of the opening. The edges of the screen fit snuggly within the tracks and the screen is slideable along the tracks. Using the pull bar, the screen can be unrolled from the coil, pulled through the tracks to the bottom of the opening, and secured to the bottom of the opening, for example, with a catch or any other means known in the art, such that the screen fully covers the opening and is substantially sealed about the periphery of the opening.

In an example embodiment, the screen assembly includes valance 146 connected to the door, for example, at least indirectly hingedly connected to the top rail. The valance is positionable to at least partially enclose the coil or housing, for example, as shown in FIGS. 2 and 5. In an example embodiment, the valance is connected to spacer 147, which in turn is connected to the door, for example to the top rail. The valance is displaceable to enable the screen to be extended past the valance to cover the opening. For example, the valance is hinged, using hinges 148, such that the valance can be pivoted between a closed position as shown in FIG. 5 and an open position as shown in FIG. 6. In an example embodiment, latches 149 are used to lock the valance in the closed position. Once the screen is pulled down to cover the opening, the valance can be returned to the closed position, for example, as shown in FIG. 4. Thus, the valance conceals the coil or housing. In an example embodiment, the valance is used to secure panel 118 in the closed position, for example, as shown in FIG. 5, avoiding the use of additional hardware that would increase cost and complexity and adversely impact the aesthetic appearance of the door.

In an example embodiment, door 100 includes molding 150 encircling the opening and partially extending into the opening. In an example embodiment, in a closed position, panel 118 engages the molding. In an example embodiment, weatherstrip 152 is attached to panel 118 and in the closed position, engages the molding.

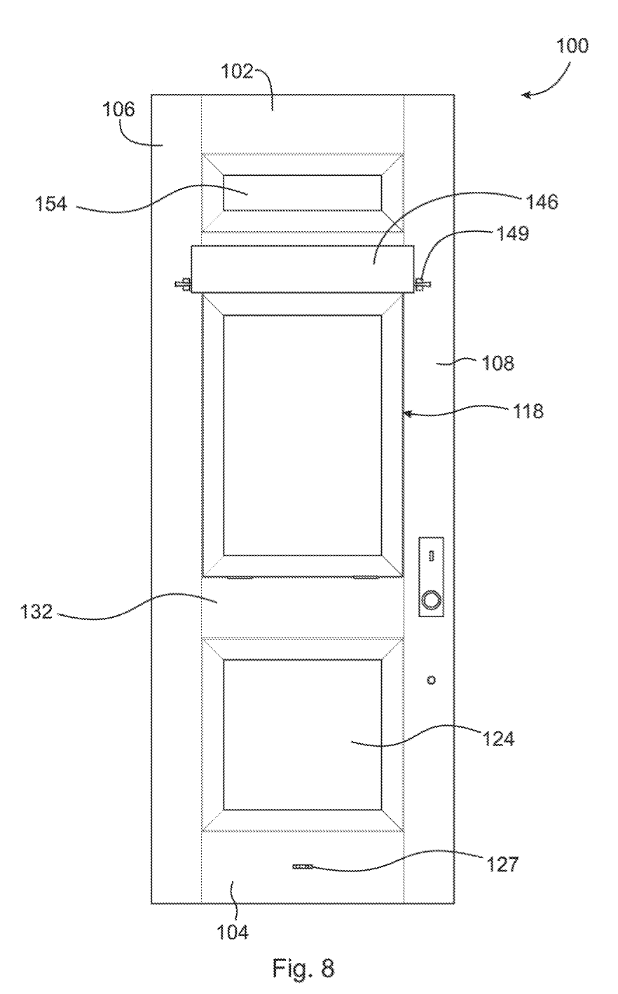

FIG. 8 is a back view of three panel door 100. In an example embodiment, door 100 includes panel 154, that is, there are three panels in the door. Panel 154 is located between the opening and the top edge of the door. The discussion supra regarding panel 118 and the screen assembly is applicable to door 100 with panel 154.

Door 100 presents a desirable aesthetic appearance, while providing ventilation functionality and minimizing hardware and components necessary for effecting ventilation through the door. In the closed position for panel 118, panel 118 appears to be a fixed panel, for example, similar to panel 124. That is, door 100 appears to be a normal paneled door. For example, molding 150 would be substantially the same if panel 118 were a fixed panel similar to panel 124. When door 100 is an exterior door, in the open position for panel 118, opening 116 and screen 128 advantageously provide screened ventilation through the door. However, desirable aesthetic elements are preserved for the door. For example, to a viewer viewing the exterior of the door, interior portion 156 of panel 118 is visible in the closed position, mimicking a fixed panel, and is replaced by the screen in the open position. Further, a separate screen door, which would partially obscure the exterior of the door is not required, which provides aesthetic, functional, and cost-savings advantages. In like manner, a fixed screen or a removable screen, both of which would detract from the appearance of the door, are rendered unnecessary.

Thus, the aesthetic appearance of the various components of the door, such as rails, stiles, panels, and moldings is preserved, while minimizing structural components related to ventilation functionality. Also, the screen assembly, with the exception of the screen itself in the open position for panel 118, is hidden from exterior view. Stated otherwise, in the closed position, door 100 has the appearance of a standard entry door.

Door 100 also has aesthetic and functional advantages from an interior perspective. For example, to a viewer viewing the interior of the door, panel 118 appears as a fixed panel in the closed position and is replaced by the screen in the open position. Advantageously, in the open position, panel 118 is hinged to swing downward to align with the space below the opening, for example, to at least partially align with panel 124. In the open position, panel 118 mimics the appearance of a fixed panel, such as panel 124. Thus, the basic perception and aesthetics of a door with fixed panels is preserved. Panel 118 in the open position mirrors opening 116. Also, the screen assembly, with the exception of the valance and the screen itself in the open position for panel 118 is hidden from exterior view. The valance can be configured to blend with or accentuate the aesthetic and structural aspects of the door. Further, in the open position, panel 118 does not interfere with function of the door, such as opening the door, which would be the case if the panel swung sideways for example, such that portions of the panel extended beyond the side stiles of the door. Further, by swinging completely out of opening 116 to a point below the opening, the entire area of the opening is available for ventilation, a possibility not possible with sliding screen arrangements.

It should be understood that door 100 is not limited to the number, size, shape, and relative proportions of stiles, rails, panels, or other components shown and that other numbers, sizes, shapes, and relative proportions of stiles, rails, panels, or other components is possible. For example, the relative size, shape, and configuration of opening 116 can be modified, and the door can be sized to fit various door openings as needed.

Although the examples above show or reference a specific number, type, and configuration of components, it should be understood that according to aspects illustrated herein, other numbers, types, or configurations of components are possible.

It will be appreciated that variations of the above-disclosed and other features and functions, or alternatives thereof, may be desirably combined into many other different systems or applications. Variations presently unforeseen or unanticipated alternatives, modifications, variations, or improvements therein may be subsequently made by those skilled in the art which are also intended to be encompassed by the following claims.

What I claimed:

1. A door, comprising:
an opening passing through the door;
a first panel hingedly connected to the door between the opening and a bottom edge of the door such that in a closed position the panel covers the opening and in an open position all of the panel is aligned with the door between the opening and the bottom edge; and,
a screen assembly secured to the door and including a displaceable screen, wherein:
for the open position, the screen is extendable to cover the opening; and,
for the closed position, the screen is retractable about a coil.

2. The door of claim 1 wherein the screen assembly is located between the opening and a top edge of the door.

3. The door of claim 1, further comprising:
a top rail, a bottom rail, and first and second side stiles;
a lock rail forming a portion of the opening; and,
a second panel located between the lock rail and the bottom rail, wherein:
the top rail, the bottom rail, and the first and second side stiles form an outer circumference for the door;
the bottom rail includes the bottom edge; and,
the first panel is hingedly connected to the lock rail.

4. The door of claim 3 wherein the screen assembly includes a valance at least indirectly hingedly connected to the top rail and positionable to at least partially enclose the coil.

5. The door of claim 3 wherein in the open position respective portions of the first and second panels are in registration.

6. The door of claim 3 wherein in the open position, at least a portion of the first panel faces the second panel.

7. The door of claim 1 further comprising a molding encircling the opening, wherein in the closed position, the first panel engages the molding.

8. The door of claim 1 further comprising:
a molding encircling the opening; and,
a weatherstrip attached to the first panel, wherein in the closed position, the molding engages the weatherstrip.

9. A method of fabricating a door, comprising:
forming an opening in the door;
hingedly connected a first panel to the door between the opening and a bottom edge of the door; and,
securing a screen assembly to the door, wherein:
the first panel is displaceable to cover the opening in a closed position;
the first panel is displaceable such that the first panel is aligned with the door between the opening and the bottom edge in an open position; and,
the screen assembly includes a screen extendable to cover the opening in the open position and retractable about a coil in the closed position.

10. The method of claim 9 wherein securing a screen assembly to the door includes locating the screen assembly between the opening and a top edge of the door.

11. The method of claim 9 further comprising forming an outer circumference of the door by joining a top rail, a bottom rail, first and second side stiles of the door, wherein:
the bottom rail includes the bottom edge;
the door includes a lock rail forming a portion of the opening;
the door includes a second panel between the lock rail and the bottom rail; and,
hingedly connected a first panel to the door includes hingedly connecting the first panel to the lock rail.

12. The method of claim 11 further comprising at least indirectly hingedly connecting a valance for the screen assembly to the top rail, wherein the valance is positionable to at least partially enclose the coil.

13. The method of claim 11 wherein the first panel is displaceable such that respective portions of the first and second panels are in registration.

14. The method of claim 11 wherein the first panel is displaceable such that respective portions of the first and second panels face each other.

15. The method of claim 9 further comprising encircling the opening with a molding, wherein the first panel is displaceable such that the first panel engages with the molding.

16. The method of claim 9 further comprising:
encircling the opening with a molding; and,
securing a weatherstrip to the first panel, wherein the first panel is displaceable such that the molding engages the weatherstrip.

17. A door, comprising:
an opening passing through the door;
a first panel;
a second panel between the opening and a bottom edge of the door;
a lock rail between the first and second panels;
at least one hinge connected to the first panel and to the lock rail; and,
a screen assembly secured to the door and including a displaceable screen and a coil about which the screen is retractable, wherein:
the screen assembly is located between the opening and a top edge of the door;
in a closed position, the first panel fits within the opening to fill the opening and the screen is retracted about the coil; and,
in an open position, at least a portion of the first panel faces the second panel and the screen is extended beyond the coil to overlap the opening.
